(19) United States
(12) Patent Application Publication
(10) Pub. No.: US 2012/0052941 A1
(43) Pub. Date: Mar. 1, 2012

(54) METHOD AND SYSTEM FOR MULTIPLE PLAYER, LOCATION, AND OPERATOR GAMING VIA INTERACTIVE DIGITAL SIGNAGE

(76) Inventor: Cheuong K. Mo, San Diego, CA (US)

(21) Appl. No.: 12/870,821

(22) Filed: Aug. 28, 2010

(51) Int. Cl. A63F 13/00; G06Q 30/00; A63F 9/24; G06F 15/16

(52) U.S. Cl. 463/30; 709/223; 709/218; 705/14.49; 463/29

(57) ABSTRACT

A system and method for a multi-player, multi-operator and multi-location interactive game system that is displayed at public venues via digital signage devices, otherwise known as location-based interactive content devices. A widget comprising a variety of games superimposed upon full screen advertisements is customized to the operator's selection, and may be run on either: a server cluster, or an operator's computer. The system provides enhanced speed and game performance by using content servers to store image, text, graphics, or other types of files associated with a game.

### FIELD OF INVENTION

The present invention is related to systems and methods for simultaneously operating multiple interactive digital signage devices linked with multiple users via electronic communication devices, and in particular for use in game playing while running background advertisements.

### BACKGROUND OF THE INVENTION

There is a rapidly increasing demand in the advertising and media entertaining industry to use electronic display devices in public venues to simultaneously entertain and market products to viewers. This marketing method has commonly come to be called “digital signage” marketing or “location-based content display” because the advertising is targeted to consumers at specific locations, rather than the previous general viewing audience. The displays may provide digital marketing images and/or they may be interactive in which the viewing audiences can send messages to the screens via their personal communication devices to, for example, post messages or participate in games against other viewers. A recent Frost & Sullivan report estimates that the digital signage advertising industry in North America alone will reach $3.7 billion by 2011.

The main advantages digital signage provides over other established forms of advertisement are: a reduction in the total cost and amount of time required in creating, producing, and displaying the advertisement; the falling prices of electronic products and data-storage systems; and a concurrent increase in targeted marketing to selected consumer groups. The industry must still overcome some technological hurdles before digital signage is widely accepted. For example, the continuity of a user interacting from one display to another display at a different location and the effective display of advertising continue to be a concern.

Digital signage devices also have the limitation of requiring that operators be able to distinguish specific displays from other displays within a multitude of locations. To address this problem some companies assign a unique access code or identifier for each display. A prime example of this limitation is disclosed in U.S. Pat. No. 7,450,954, entitled “System and Method for Location-based Interactive Content”, where each digital screen also has a unique display identifier or access code. Since the access codes are different for each display, consumers who migrate from one display to the next display must input another code in order to engage with each display. The different access codes for each display make the interaction more difficult for these consumers.

Additionally, traditional digital signage devices that have functioned primarily as targeted marketing devices have had limited marketing impact because of the lack of screen space for the placement of advertisements. They typically involve multiple images co-located within a screen in specified areas commonly known within the industry as “zones”. For example, U.S. Patent Application 20080060003, titled “Methods and Systems for Self-Service Programming of Content and Advertising in Digital Out-of-Home Networks”, discloses typical advertising content wherein the screen is divided into multiple segments. More precisely, FIG. 5 of this application discloses a digital screen displaying four different advertisements running one each per screen border, and five additional data boxes inside the border advertisements. Viewers who watch a content zone do not necessarily pay attention to the other adjacent zones used for advertisements. Likewise other systems, such as Wiffiti.com's advertisement of an automobile, use the full background screen for one advertisement, while the image is largely obscured with multiple text boxes overlaying the advertisement background.

There is therefore a need within the digital screen advertising industry to provide marketing images that are clear, comprehensible, aesthetic, and integrated with the content, while also being entertaining The present invention provides this by disclosing an interactive digital signage device wherein a full screen advertisement runs on the screen background while a game, sometimes translucent, is played in the foreground. The present invention also overcomes technological hurdles associated with interactive digital signage device with a number of system improvements.

### SUMMARY OF THE INVENTION

The present invention comprises a novel digital signage display that overcomes the restriction of current zone designated, space limiting advertising. A widget of the present invention displays an advertisement, or a time sequence playlist of advertisements on the screen while one or more games are overlaid on top of the advertisement. The game may be translucent to permit the advertisement to be concurrently viewed behind it.

The present invention also comprises a multi-operator, multi-player and multi-location game system that is displayed at venues via digital signage devices. A widget comprising a variety of games and information is customized to the operator's selection, and may be run on either a server cluster, a local server, or an operator's computer connected to or integrated with a digital display. Enhanced speed and game performance occurs in the use of widgets with local devices because image, text, graphics, or other types of files associated with a game are readily available in storage on local computers or servers.

Embodiments of the present invention also provide improvements over previous location based content methods and systems by providing a multiple operator, multiple user, and multiple electronic display device systems. The electronic display devices within a network of electronic display devices may be co-located at the same venue or reside at different geographical locations. In a preferred embodiment of the present invention, multiple operators, each with their own network of electronic display devices and multiple players, are simultaneously logged into or interacting with the same system. Therefore, since it is not necessary to install or deploy multiple system copies for operators or players, a single system is cheaper and easier to monitor.

In a further embodiment of the system, there is no need to configure a unique display access code for each digital signage screens within a network, thus reducing the complexity in tracking unique display access codes. Each display device within an operator's network shares a common display access code. Likewise, each of the multiple operators in the system share the same common display access code.

Another preferred embodiment comprises the remote content server residing separately from the server cluster, and being used as a file storage device for files to be accessible via a URL, without the need to provide any processing functionality or communications with the server cluster.

Additionally, in another embodiment, the widgets will automatically communicate with one or more backup server clusters in the event of interruption of service to the primary server cluster.

These improvements, as well as others in the system configuration and method of using multiple screens and content servers, results in faster, cheaper, and more reliable multi-player, multi-operator, and multi-location user interaction for activities, such as game playing and advertising.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates the architecture of the system of the present invention.

FIG. 2A illustrates flowcharts for operator's interaction with the system.

FIG. 2B illustrates an exemplary embodiment of an advertisement superimposed with a game played on the foreground of a digital signage device.

FIG. 3 illustrates flowcharts for player communication with local and remote servers.

FIG. 4 illustrates flowcharts for methods of game score calculation.

### DETAILED DESCRIPTION

Within this description, specific components and systems are disclosed that one of skill in the art would recognize as being interchangeable with other known items within the art; and thus are not described in detail so as to obscure the present invention. It is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims.

The present invention comprises a system and a method for providing location-based content for use in interactive multi-player activity, such as simultaneous multi-player game playing via digital signage and personal communication devices. Personal communications device” includes but not limited to mobile phones, PDA, computers, and any device capable of communication It is noted that within the context of this disclosure, the terms “location-based content”, and “location-specific content” are used interchangeably, and the terms “digital signage”, “digital signage screens”. “display devices”, and “electronic display devices” are used interchangeably.

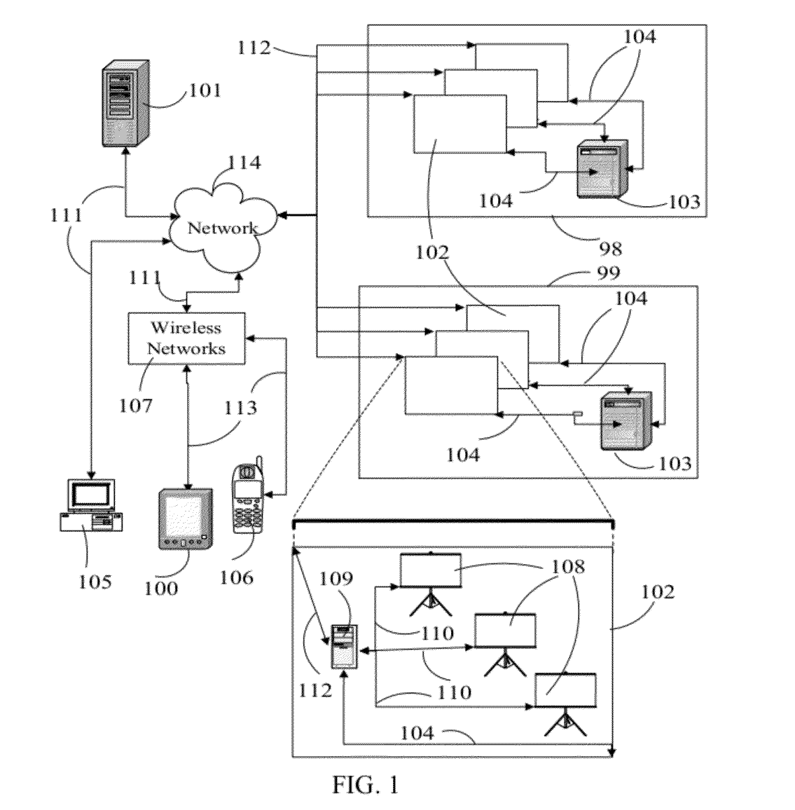

By way of exemplification, the system and method of the present invention are depicted in diagrams/flowcharts illustrated in FIGS. 1, 2, 3, and 4. The devices of the present invention are networked together with a combination of wireless and wired systems, as referenced in FIG. 1: ‘104, 107, 110, 111, 112, 113, 114’. And, in FIG. 1, the following devices are referenced by:
‘100’ is a personal communication device, including but not limited to a personal digital assistant device, mobile phone, or computer with network access and/or messaging capability.
‘101’ server cluster is a primary and/or a backup server cluster that controls and stores all communications functions. When the primary server is “down” or not available, it is replaced by a backup server cluster;
‘102’ is station comprising of one or more electronic display devices 108, otherwise known as digital signage screens connected to operator's computer 109; said station residing at different locations 98 and 99;
‘103’ is a content server, located remote or local to the digital screens, and that function primarily as a storage device for computer files accessible via a URL;
‘105’ is a personal communication device including but not limited to a laptop or a desktop computer, with wire line or wireless network access;
‘106’ is a personal communication device, including but not limited to a cellular phone with network access and/or messaging capability;
‘108’ is a network of electronic display devices that can receive and display content from both the server cluster 101 or the content servers 103 by way of operator's computer 109; and
‘109’ is an operator's computer that is connected to or is integrated to the electronic display device ‘108’;
A preferred embodiment of the system comprises a plurality of electronic display devices (FIG. 1, 108) linked with at least one content server 103; as well as a local operator's computer 109 that may be connected to or integrated with a display device 108, and wherein users or players interact with said display devices 108 via personal communication devices, such as computer 105 not limited to laptops, desktops, notebook computers, Personal Digital Assistant devices, and personal communications devices 100, 106 not limited to PDA's and mobile phones.

The electronic display devices 108 are those comprising light emitting diode (LED), liquid crystal display (LCD), plasma monitors, Cathode Ray Tube (CRT), or other visual communication medium that may be used as a “digital signage” device or a “location-based content display” device. In a preferred embodiment of this invention said digital signage devices 108 are located in venues (e.g. bars, restaurants, stores, lobbies, cafeterias, cinemas, etc.) for the purpose of presenting digital content that will simultaneously entertain viewers with a variety of content or games while they view advertisements. There may be one or more display devices 108 co-located with or at different locations that are linked together on the same network. For example, in a station 102, there can be multiple display devices 108 co-located within a bar that can alternatively be linked with multiple display devices 108 in other stations 102 located throughout a community.

### Server Clusters and Content Servers

The system of the present invention also comprises a server cluster comprising of primary and/or a backup server clusters (FIG.1, 101), which are one or more servers in the same or different geographical location. The backup server cluster functions in lieu of the primary server cluster when communication to the primary server cluster is interrupted. Servers may operate independently or clustered for High Availability. The primary server cluster of the present invention controls and can support all communication functions to include those to and from players' personal communications devices 100, 106 and links to content located on the content servers 103. The primary server cluster 101 can be configured to not receive, filter, or store any content for advertising except for links to the content. The server cluster 101 responds to widgets hosted on the server cluster 101 or launched from operators' computers 109 that are co-located and linked to the display devices 108. The system also provides for multiple operators simultaneous participation wherein the operators, such as business owners with a defined geographical area, would log into a common interface on the server cluster 101 to make game and advertisement selections to be rendered on the display devices 108 within their business.

The system of the present invention also comprises one or more content servers (FIG. 1, 103), that may be remote from or local to and connected to digital display devices 108 via a network connection 104 such as local area network (LAN), Wireless Wide-Area Network (WWAN), or other wire line and wireless network connections. The content servers 103 may be separate from the server cluster 101 or be a part of the server cluster 101. The content servers 103 function primarily as a storage device for computer files and content accessible.

The content server 103 can be a server, or a file storage device integrated with the digital display. The widget running on operator's computer 109 retrieves the necessary files or media content from such content server 103 to render onto a display device 108. The content server 103 can be any online source where content can be retrieved via a specific URL. The ability of the widget to retrieve such content from public or private sources, instead of having the content sent directly from those sources or from the server cluster, saves on server cluster loading and achieves faster download speed if the content server 103 is located near the operator's computer 109. Furthermore during the content retrieval and rendering process, there is no need for the widget to communicate with the server cluster 101 which saves on server cluster loading.

Additionally, in the event of interruption of service to the primary content server 103, the widget will optionally automatically communicate with a backup content server. Furthermore the widget can communicate with a backup server cluster in the event the server cluster 101 does not respond. This avoids interruptions of consumer interaction and experience with the display content.

In addition to primary content server 103, the system of the present invention also comprises a backup content server linked to the operator's computer 109 via wire line or wireless network connections 104. All of the information stored on the primary content server 103 is replicated on the backup content server in the event that connection to the local content server is interrupted. This prevents interference and delays in game playing.

### Common Display Access Code & Content Access Code

Common Display Access Code & Content Access Code may be announced on display device, TV, internet, or other media. Each widget is responsive to a common display access code along with multiple content access codes so that players with communications devices 100, 106 and/or computer 105 may interact with a desired game and/or compete against each other after sending said access codes to server cluster 101. A “common display access code” may be a Uniform Resource Locator (URL), a short message service short code, a telephone number, or other code that establishes connectivity to allow a personal communications device 100, 106 or computer 105 to communicate with a server cluster 101. The same common display access code can be utilized for at least one operator's computer 109. Instructions may be shown on a display device 108 to ask players to visit the same URL site, or display access code, using a mobile web browser regardless of the location of the display device. Once the URL is visited, the consumer would enter a specific content access code found on the display device 108 into a data input field at the URL and submit it to start interacting with the multimedia content on the display device 108. The content access code is unique for each multimedia content selection available to a consumer at each station 102.

By way of exemplification, a public venue comprises two networked display devices 108 each providing the same trivia game. The two display devices 108 show the same common display access code (e.g., xyz.com), which the consumer would visit with their mobile web browser device. The display devices 108 would also show different content access codes for launching the same type of game, wherein the first display device 108 shows content access code comprising at least one or more symbols or alphanumeric characters such as “TRIVIA ABC”, and the second display device 108 shows “TRIVIA DEF”. Depending on which display device the consumer was watching would determine which content access code they would enter at the URL display access code “xyz.com”. With a common URL display access code, access to the system is greatly simplified for the consumer, especially in a display network consisting of thousands of stations 102.

By way of another exemplification, a display device 108 would show a screen menu with three games having content access codes “GET GAME1, GET GAME2, GET GAME3”, as well as a display access code URL address “XYZ.COM”. Players with data web access on their communication device 100, 106 or computer 105 would visit “XYZ.COM”, and enter a content access code, such as “GET GAME2”. Likewise, players with personal communications devices having only Short Message Service (SMS) functionality, commonly known as “text messaging”, would type in a game selection with a different unique content access code listed on all of the digital display devices, such as “GET GAME1 to 55555”, where “GET GAME1” is the content access code, and “55555” is the common display access code. Likewise, players may call a phone number to access an Interactive Voice Response (IVR) system to enter the common display access code and content access code.

In a further embodiment of this invention, a consumer with a personal communications device 106, 100 or computer 105 may select more than one game for viewing on the digital display device 108. By way of exemplification, a consumer would text “GET GAME1 to 55555”, “GET GAME2 to 55555”, and “GET GAME3 to 55555”. This would subsequently launch all three games rendered on different regions of display device 108 without requiring further selection input by the consumer.

And, in a preferred embodiment of this invention, multiple consumers who have entered the same content access code, and thus selected the same multimedia content to view, would play against each other. The consumers can be co-located and viewing the same digital display device 108, such as a group sitting at the same table in a restaurant. They could also be competing against other consumers who have entered the same content access code within the same network of digital display devices 108 at other stations 102 located at a different venue.

### General Process Flow

Furthermore, the devices and network of FIG. 1, may comprise one or more of the following, as disclosed in US Patent Application 20090189828, the entirety of which is incorporated herein as a reference for types of devices and networks: a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network(MAN), a Wireless MAN (WMAN), a Wide Area Network (WAN), a Wireless WAN (WWAN), a Personal Area Network (PAN), a Wireless PAN (WPAN), devices and/or networks operating in accordance with existing Institute-of-Electrical-and-Electronics-Engineers (IEEE) 802.15, IEEE 802.15.3c, WirelessHD (WiHD), and/or Ecma TG20 standards and/or future versions and/or derivatives and/or Long Term Evolution (LTE) of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a wired or wireless handheld device (e.g., BlackBerry, Palm Treo), a Wireless Application Protocol (WAP) device, or the like. And with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth, Global Positioning System (GPS), Wi-Fi, Wi-Max, ZigBee™, WiHD, Ultra-Wideband (UWB), Global System for Mobile communication (GSM), 2G, 2.5G, 3G, 3.5G, 4G or the like. Some embodiments may be used in various other devices, systems and/or networks.

FIG. 1 depicts the overall process flow in accordance with a preferred embodiment. Station 102 can be located in a public venue, such as a bar, restaurant, store, lobby, cafeteria, cinema, etc. . . . ; and comprises electronic screens (e.g. not limited to LED, LCD, CRT or Plasma monitors) connected to content server 103. Each display device 108 within station 102 is connected to and under the control of the same operator's computer 109. Any one venue may comprise one or more of said stations in one area, such as one or more display devices 108 located throughout a sports bar, and connected to an operator's computer 109. Likewise, multiple stations 102 may also reside at different locations 98 and 99 connected to and communicating with the same server cluster 101. Multiple stations 102, at the same location 98, or at different locations 98 and 99, may utilize a same or a different content server 103.

The display device 108 screen shows the display access code, such as a text message number or a URL address, as well as various content access codes for the audience to interact with the display device (108) for the purpose of, for example, initiating a game. Members from the general public subsequently uses their personal communications device (106, 100) to send common access code, content access code, and other data in one or more iterations to server cluster 101 via connections (111, 113) and networks (107, 114). Alternatively, the customer may use their personal computer 105 to send messages (common access code, content access code, and other data) in one or more iterations to server cluster 101 via connection 111 and network 114.

Server cluster 101 stores said messages and responds by sending a corresponding reply to said members' personal communication device 106, 100 or personal computer 105. The server cluster 101 sends game data associated with said messages to stations 102 at locations 98 and 99 via network 114, for the purpose of, for example, to initiate a game running in a widget in operator's computer 109 which updates the game content rendered on display device 108. A widget running on operator's computer 109 in station 102 can also receive extra content from server cluster 101 or from content server 103.to render said extra content with said game data on display device 108.

Additionally, each widget running in operator's computer 109 can query the server cluster 101 for data as needed via network 114 and connections 112, 111. Server cluster 101 then optionally responds with the requested data to the querying widget. For example, each widget can send a request for game content which requires a response from server cluster 101, or alternatively each widget can send game progress updates to server cluster 101 for purpose of game synchronization as experienced by said members.

### Widgets

It is also specifically noted that the system and method of the present invention significantly differs from other previously known location-based interactive content systems because of the implementation of novel widgets. The widgets of the present invention can run independently on the operator's computer 109 via for example a Flash or animation application, or can be run on server cluster 101. The widgets of the present invention can run with or without persistent connections with server cluster 101. The widgets establish connections to the server cluster 101 on an as needed basis via connections 112, 111, and network 114.

When the widget is running, it will query server cluster 101 for information such as, game configurations—types of games, number of games, number of questions per game, URL's of content files in the content server, timing data, and other parameters associated with operator's computer 109. The widget will also query server cluster 101 regularly for updates to see if the player has sent any input from their personal communication device, such as selection of a particular game or an answer to game question.

### Same Copy System

The present invention also overcomes technological hurdles associated with interactive digital signage devices with a number of system improvements. All of the operators and consumers are simultaneously logged into the same copy system rather than logged into several systems each supporting different operators and consumers. As a result, the same copy system is cheaper and easier to monitor, although several copy systems can also be deployed in the present invention. The operators may be independent individuals or companies who utilize the system to distribute content to their stations 102. Each operator can login to the system to configure a list or menu of specific contents for each widget from an entire of library of media choices, wherein the content may include any media such as images, audio, video, text, games, or other multimedia content. By way of exemplification, the operator would login to server cluster 101 to configure a widget with games and content for their stations 102. To accomplish this, the operator would create a list or menu of games with optional advertisements along with the location identifier of the content to be retrieved. When the widget configuration is completed, the games and content would be available for viewing on the display devices 108.

This “one copy system” can support multi-operators and consumers and therefore it is not necessary to deploy separate systems for each operator. The cost savings of consolidation and ease of monitoring are achieved.

### Game Overlay on Background Advertisement

The present invention also comprises the use of digital signage in public venues for both entertainment of and product marketing to the viewer. In one preferred embodiment a display devices 108 renders an advertisement on the display background while a game runs on the display foreground. Because the advertisement blends into the game background, viewers can watch a less prominent portion of the advertisement in the region where the game is rendered. While engaging with the game, the viewers are likely to watch the more prominent advertisement content in another region of the display background that is not obstructed by the game. Therefore, the present invention is a significant improvement over previous displays which rely on zone advertising that cause content discontinuity on the display device.

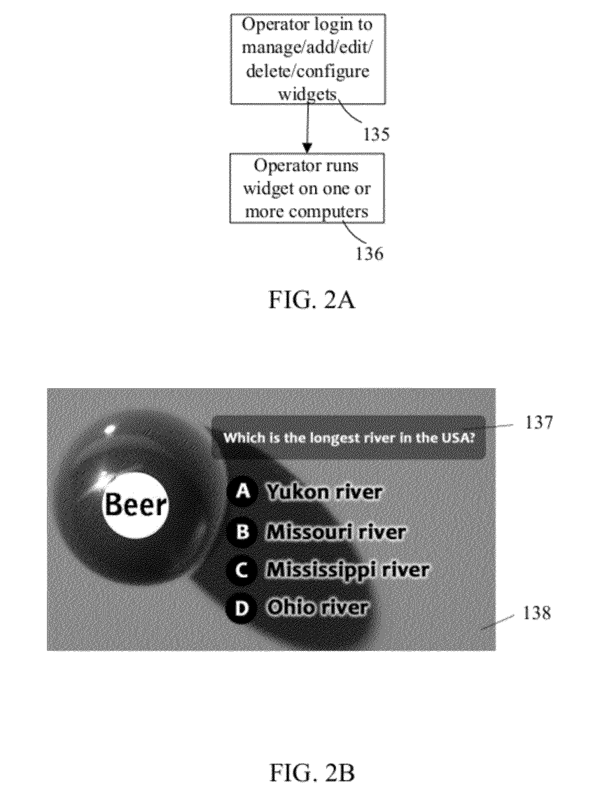

In FIG. 2A, the widget configuration for games and advertisements is created by the venue operator logging (FIG. 2A, 135) into server cluster 101 on the network and selecting from a library of multimedia choices. By way of exemplification, the operator would create a list or menu by selecting which games are to be made available for play, which advertisements, the speed of play, whether the background of the game would be translucent, whether to have background music, and other parameters to be received by a widget. The present invention is in no way limited by this exemplification, and may comprise a multitude of combinations for the operator's selection, such as pre-packaged options, wherein the selection choice combines a predetermined set of games with a set of advertisements. The operator subsequently activates the widget on the operator's computer 109 to display their selection choice of a menu of games superimposed on advertisements, as in FIG. 2A, 136.

FIG. 2B shows an exemplification of the present invention wherein an advertisement 138 fills the entire or a majority of the background region of the screen while a game 137 overlays on top of it. The game components may be translucent such that the advertisement can be viewed behind the game. The region occupied by the game may also be superimposed from about 10% to about 90% onto the total screen region, and typically about 50%, which reserves the remaining area solely for advertising space where advertising content can be made more prominent.

The advertisements can also change during the game with a controlled preprogrammed sequence. And the image can be made more aesthetic and entertaining by having the text, such as answer options in a multiple choice question, be displayed and fade off the screen individually. One of skill in the art would know how to program the game so as to achieve similar visual effects.

### Multi Player Game Playing Exemplification

The system and method of the present invention can be further explained via an exemplification involving a multiple game player, multiple location, and multiple operator interactive digital signage setup.

Another preferred embodiment of this invention is the use of the digital signage for facilitating multi-player game competitions, with or without background advertisements. Previous devices have multiple game operators and/or players each using a copy of the system software. The present invention is an improvement upon this wherein all of the operators and/or players are simultaneously logged into or interacting with the same copy of the system software making it cheaper and easier to monitor. The system software and the widgets reside on the server cluster FIG. 1, 101, or the widgets may reside on an operator's computers 109.

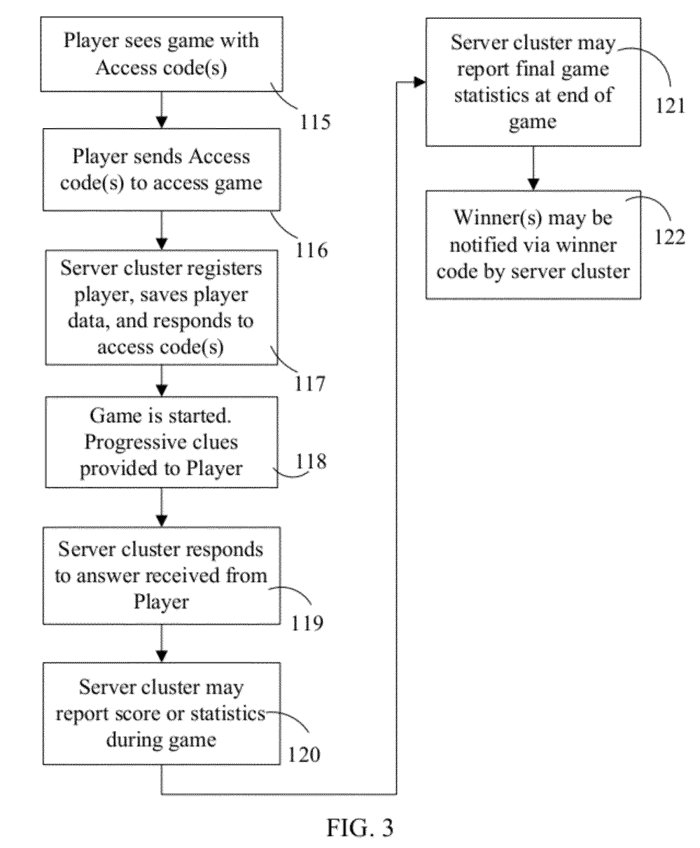

The games in a widget can be set up by the operator to run automatically or on command following the game player accessing a display access code and a content access code. By way of exemplification of running the games on command, a game player with a personal computer 105 with Internet connection or with a personal communications device 100 or 106 would obtain a common display access code comprising a common display access code such as a uniform resource locator (URL) address, along with a content access code from the digital signage screen, TV or other media, as per the flowchart of FIG. 3, 115. Alternately, the common display access code may include a text message short code number. In FIG. 3, 116-117, the common access codes is sent by the player from a device in FIG. 1, 100, 105, or 106 and received by server cluster (FIG. 1, 101), which subsequently allows the player to send personal identifier information such as phone number or other unique personal identifiers along with the content access code. All players of 105, 106, and 100 who entered the same common access code and content access code would then compete against each other in the game.

In FIG. 3, 118, the server cluster responds by initiating play of the game which provides progressive clues until the game answer is revealed to the player. By way of exemplification, providing progressive clues in a Trivia game by eliminating each wrong multiple choice answer until one right answer remains, in a word scramble game by unscrambling each letter in a word until all letters are unscrambled, or not limited to in other games by providing clues until the right answer is revealed. In FIG. 3, 119, each subsequent input by the players in interacting with the game is sent to the server cluster which responds back to the players of 105, 106, and 100, with messages, scores, game statistics, player ranking, and/or winner code (FIG. 3, 119-122). The players' scores and rankings can also be displayed at the end of each game, or at the completion of the entire set of games within the widget, on the display device 108 or on a player's electronic communications device 100, 106, or computer 105. Concurrently, the scores along with a winner code can be sent to the players' electronic communication device (105, 106, 100), wherein the player presents the winner code to the game operator so as to receive a “prize”.

As stated above, the game widgets can be hosted on the server cluster at FIG. 1, 101. It can also be downloaded on a wire line or wireless network to operator's computers 109 to be run by game operators, such as venue owners. This system provides the flexibility of allowing third party digital signage systems and media players to access and play the games. Game widgets and the underlying advertisements are not limited to one selection. For example, one widget can comprise a sequence of games and/or advertisements. The sequence selection is determined by the game operator, i.e., venue owner. The speed of the game can also be controlled by the operator or player via various control methods.

Updates: Previous systems may require that all computers hosting game widgets have a persistent connection to the server cluster in order to receive updates. The present invention is an improvement because it can have, but does not require a persistent connection. Instead, the operator's computers 109 hosting the widgets can also request updates from the server cluster 101 on a periodic basis without maintaining a persistent connection, and then render and display said updates onto display devices 108.

No Game Disruption. This invention has the advantage of minimizing game disruption as compared to previous multi-user multi-location game playing enterprises because it relies on multiple servers. If the game widget detects no response from the primary server cluster (FIG. 1, 101), it may then communicate with the backup server cluster which stores replicated information to prevent game disruption. By way of exemplification, if a game widget receives no response from at least two server clusters, it could determine that its local network connection was down. It could then finish playing its current game and provide game statistics and scores up to the time of the network outage. Alternatively, the widget can continue to run the game applications or display other content that is locally available and that does not require network access.

Multiple Player and Location Competitions: The server cluster (FIG.1, 101) can simultaneously support multiple operators, locations, and games. A game operator merely logs into the server via a computer with network access such as an operator's computer 109, and selects the games sequence to be played in a widget on their operator's computer 109. Because said display devices 108 do not need to be co-located, but can reside in various locations, players can compete against players at their venue or against players at another venue within the network.

### Game Score Calculation

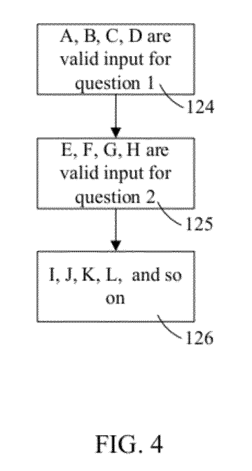

FIG. 4, 124-126, discloses by way of exemplification a method for determining an individual player's game score when there is a time difference in answering, such as due to a network delay. When a player's response to a multiple choice question is delayed, the server cluster relies on associating the received characters or symbols associated with a particular question's choices, such as A-D (124). By way of exemplification, a previous game question has A-D (124) answer choice group. The current active game question has E-F (125) answer choice group. If server cluster 101 receives an “A” answer from a player, then this answer “A” was intended for the previous question. Different set of answer choice groups may be implemented, such as E-F (125), I-L (126) and so on. Eventually, the answer choice groups are repeated, once sufficient time has elapsed for the server to associate the player's delayed response with the proper question.

Security: The present invention provides added security over previous multi-user and location systems in two main areas. First, by relying upon methods of time of receipt of game responses answer, the system is prevented from being tampered with to receive tampered external timestamp that may be provided by electronic communications device (105, 106, 100). The input that is received by a system inclusive of and between the wireless carrier system and the server cluster insures that the timestamp is valid and not modifiable by any external device. Secondly, that system may rely upon location monitoring technology to ensure the game players are located within the venue, and not being used by players outside of the venue.

### Exemplification of Types of Interactive Games

By way of exemplification, the following games may be played interactively with the present invention. It should be noted that practically any game, puzzle, riddle, etc . . . can easily be adapted to function with the disclosed system and method.

### Scramble Word Game

In a scramble game, the letters of the word are first displayed on the digital screen in a random order. The definition or description of the word may optionally be shown with the random letters. After a specified time has passed, one of the letters is unscrambled on the screen. The process continues letter by letter until the correct answer is displayed on the screen.

### Fill-in-the-Blank Word or Phrase Game

The game is initiated with blank spaces for a word or phrase being displayed on the digital screen. The definition or description of the word or phrase may optionally be shown with the blank spaces. After a specified time has passed, one of the letters within the word or phrase is displayed on the screen. The process continues letter by letter until the correct word or phrase is displayed on the screen.

### Trivia Game

A game is initiated by asking a question on the digital screen wherein multiple choice answers are given. The players must select one of the multiple choice answers displayed on the screen. After a period of time has elapsed, one of the incorrect answer choices is removed from the screen. The process repeats until the correct answer choice is the only one left on the screen.

Although the present invention has been described with reference to specific exemplary embodiments, it will be evident that various modifications and changes may be made to these embodiments without departing from the broader spirit and scope of the invention set forth in the claims. Accordingly, the specification, figures, and games are to be regarded in an illustrative rather than a restrictive sense.

What is claimed:

1. A system for providing and managing location-based interactive content, comprising:
at least one electronic display device operable to display content wherein said display device is integrated into or connected to an operator's computer;
at least one server cluster responsive to communications from at least one personal communication device and from at least one widget;
at least one content server operable as a file storage device wherein said content server resides in or is external to said server cluster;
at least one widget operable to run on said operator's computer and/or on said server cluster; and
at least one network connecting said server cluster, electronic display devices, operators' computers, personal communications devices, and content servers.

2. The system of claim 1, wherein said widget maintains a persistent and/or a non-persistent connection to said server cluster.

3. The system of claim 1, wherein said widget is operable to communicate with said server cluster and said content servers so as to render content on said electronic display device.

4. The system of claim 1, wherein said widget comprises interactive games operable to compensate for delays to responses from at least one player from at least one location.

5. The system of claim 1, wherein said interactive game covers a first region of said display device and is superimposed upon advertisements; each said advertisement covers a second region of said display device.

6. The system of claim 1, further comprising one or more copy systems simultaneously accessible to at least one operator and operable to provide content from which said widget content is derived.

7. The system of claim 1, wherein said server cluster further comprises a means to communicate via Short Message Service (SMS), Interactive Voice Response (IVR), and Internet Protocols (IP); and wherein said network comprises one or more of a wireless network, a wire line network, Wireless Wide-Area Network (WWAN) and a local area network (LAN).

8. The system of claim 1, wherein each electronic display device is responsive to a common display access code; comprising one or more of a uniform resource locator address, a short message service short code, and a telephone number; and at least one content access code comprising one or more numeric, text, or alphanumeric sequences.

9. A method for providing and managing location-based interactive content, comprising:
identifying at least one electronic display device operable to display content wherein each of said display devices is integrated into or connected to an operator's computer;
creating at least one widget on a server cluster, and/or downloading said widget to run on the operator's computer;
receiving information from at least one personal communications device to said server cluster; and
forwarding or replying with a command from said server cluster to said widget to activate said widget to display a sequence of content on said display device.

10. The method of claim 9, wherein said widget comprises at least one advertisement.

11. The method of claim 9, wherein said widget functions to communicate with said server cluster and said content servers so as to render content on said electronic display device.

12. The method of claim 9, wherein said widget comprises at least one advertisement with at least one interactive game.

13. The method of claim 9, further comprising providing one or more copy systems simultaneously accessible to at least one operator in at least one location, wherein said copy system comprises a list of multimedia content from which said widget content is derived.

14. The method of claim 9, wherein said server cluster further comprises a means to communicate via Short Message Service (SMS), Interactive Voice Response, and Internet Protocols (IP); and wherein said network comprises one or more of a wireless network, a wire line network, Wireless Wide-Area Network (WWAN) and a local area network (LAN).

15. The method of claim 9, wherein each electronic display device is responsive to a common display access code; comprising one or more of a uniform resource locator address, a short message service short code, and a telephone number; and at least one content access code comprising one or more numeric, text, or alphanumeric sequences.

16. A method of playing a game, said method comprising the steps of: (a) announcing, by at least one of electronic display device, TV and Internet, each of a predetermined common display access code and content access code to members of general public (b) accessing said game, by said members of said general public by way of at least one of a personal communication device and computer, by way of said predetermined common display access code and content access code announced in step (a); (c) registering a plurality of players from said members of said general public accessing said game by way of said predetermined common display access code and content access code by way of said at least one of a personal communication device and computer, to participate in said game; (d) saving each distinct identifier identifying a respective one of said plurality of players registered in step (c) to a database; (e) providing progressive clues to said plurality of players until at least one correct answer is revealed; (f) receiving, at said server cluster by way of at least one of said personal communication device and computer, a response representing an answer from each respective one of said plurality of players participating in said game.

17. The method of claim 16 wherein said game is displayed on at least one of electronic display device, TV, and personal communication device.

18. The method of claim 16 wherein a score is calculated and provided to each respective one of said plurality of players.

19. The method of claim 16 wherein at least one winner code is sent to each respective one of said plurality of players meeting a winning criteria.

20. The method of claim 16, wherein said server cluster further comprises a means to communicate with said at least one of personal communications device via Short Message Service (SMS), Interactive Voice Response (IVR), and Internet Protocols (IP); and wherein said connections comprises connectivity with one or more of a wireless network, a wire line network, Wireless Wide-Area Network (WWAN) and a local area network (LAN).
